(19) United States
(12) Patent Application Publication
(10) Pub. No.: US 2003/0055930 A1
(43) Pub. Date: Mar. 20, 2003

(54) Communication processing apparatus, management apparatus, computer-readable medium storing a program and communication system

(76) Inventor: Jun Haneda, Tokyo (JP)

Correspondence Address: RYUKA, 1-24-12 SHINJUKU, SIXTH FLOOR, TOSHIN BUILDING, SHINJUKU-KU, TOKYO, 160-0022, JP

(21) Appl. No.: 09/683,294

(22) Filed: Dec. 11, 2001

(30) Foreign Application Priority Data
Aug. 31, 2001 (JP) 2001-263993

(51) Int. Cl. G06F 15/173

(52) U.S. Cl. 709/223

(57) ABSTRACT

A communication processing apparatus that receives an SNMP-based command to execute the received command. A communication port, which is set as a management port, receives one or more command transmitted from a management apparatus to the communication processing apparatus, including a first command that is executable to change a setting of the management port and a second command. A storage unit stores the commands received by the communication port and an execution unit obtains the commands from the storage unit to execute the obtained commands. A re-execution instruction unit directs the execution unit to execute the second command after the first command that changes the setting of the management port, when the execution unit has executed the first command that changes the setting of the management port, such that communication with the management apparatus is maintained via the communication port.

### CROSS REFERENCE TO RELATED APPLICATIONS

This patent application claims priority from a Japanese patent application, No. 2001-263993 filed on Aug. 31, 2001, the contents of which are incorporated herein by reference.

### BACKGROUND OF INVENTION

1. Field of the Invention

The present invention relates to a communication processing apparatus, a management apparatus, a computer-readable medium storing a program and a communication system. More particularly, the present invention relates to a communication processing apparatus that processes an SNMP-based command from a management apparatus, such as, for example, a management port set command, while maintaining communication with the management apparatus.

2. Description of the Related Art

A communication processing apparatus, such as a computer, a router, or a hub on a network, is managed by a management apparatus connected to the network using SNMP (simple network management protocol). SNMP is a protocol for generating an SNMP response by the communication processing apparatus once the management apparatus transmits an SNMP request to the communication processing apparatus.

In the aforementioned network, the management apparatus typically is connected, via the network, to a communication port of the communication processing apparatus which is set as a management port. In a case where the communication processing apparatus executes one command transmitted as an SNMP request by the management apparatus, and responds to the command with an SNMP response, depending on the executed command the communication processing apparatus can not accept additional commands from the management apparatus after the processed command. For example, the executed command that prevents communication between the communication processing apparatus and the management apparatus may be a command to change the communication port used as the management port, or to change a protocol such as a communication speed or a data format of the communication port used as the management port.

### SUMMARY OF INVENTION

Therefore, it is an object of the present invention to provide a communication processing apparatus, a management apparatus, a computer-readable medium storing a program, and a communication system, which are capable of overcoming the above drawbacks accompanying the conventional art. The above and other objects can be achieved by combinations described in the independent claims. The dependent claims define further advantageous and exemplary combinations of the present invention.

According to the present invention, a communication processing apparatus that receives an SNMP-based command to execute the received command, includes: a first communication port, which is set as a management port, that receives one or more command transmitted from a management apparatus of the communication processing apparatus to the communication processing apparatus, the one or more command including a first command that is executable to change a setting of the management port and a second command; a storage unit that stores the one or more command received by the first communication port; an execution unit that obtains the one or more command from the storage unit to execute the obtained command; and a re-execution instruction unit that directs the execution unit to execute the second command after the first command that changes the setting of the management port, when the execution unit has executed the first command that changes the setting of the management port.

In an aspect of the present invention, the second command is received by the first communication port after the first command and is executable to set the management port of the communication processing apparatus to the first communication port.

In another aspect of the present invention, a communication processing apparatus, further includes: a second communication port connected to an external communication apparatus; a communication mode selecting unit that selects one communication mode of a plurality of communication modes to specify each of a plurality of communication operations of the communication processing apparatus; and a management port selecting unit that selects the management port from one of the first communication port and the second communication port, in which the management port selecting unit selects the first communication port as the management port; the execution unit obtains the one or more command stored in the storage unit to execute the obtained command when the first communication port receives the one or more command including a communication mode set command that specifies a communication mode of the communication processing apparatus, a management port set command that sets the management port of the communication processing apparatus to the first communication port, and a start execution command that instructs to start sequential execution of the one or more command stored in the storage unit; the communication mode selecting unit selects the communication mode specified by the communication mode set command, when the communication mode set command is executed; the management port selecting unit selects a default management port, corresponding to the communication mode selected by the communication mode selecting unit, from the first communication port and the second communication port; the re-execution instruction unit instructs the execution unit to execute the second command after execution of the communication mode set command; and the management port selecting unit selects the first communication port as the management port, when the management port set command is executed.

In still another aspect of the present invention, a communication processing apparatus, further includes: an interconnecting unit that interconnects communication between the first communication port and the second communication port; and a VLAN setting unit that sets the interconnecting unit to control communication between the first communication port and the second communication port corresponding to the communication mode selected by the communication mode selecting unit.

In still another aspect of the present invention, a communication processing apparatus, further includes: a second communication port connected to an external communication apparatus; an interconnecting unit that interconnects communication between the first communication port and the second communication port, in which the execution unit obtains the one or more command stored in the storage unit to execute the obtained command when the first communication port set as the management port receives a start execution command that instructs to start sequential execution of the one or more command stored in the storage unit, and it is determined that the interconnect of the communication between the first communication port and the second communication port, received before the first communication port receives the start execution command, is completed.

According to the present invention, a communication processing apparatus, further includes: a second communication port connected to an external communication apparatus; an interconnecting unit that interconnects communication between the first communication port and the second communication port, in which the execution unit delays the interconnect of the communication between the first communication port and the second communication port until execution of the one or more command stored in the storage unit is completed, when the communication between the first communication port and the second communication port is received after the first communication port set as the management port receives a start execution command that instructs to start sequential execution of the one or more command stored in the storage unit.

In an aspect of the present invention, a management apparatus that transmits one or more SNMP-based command to a communication processing apparatus having a communication port set as a management port which receives the one or more command; stores the one or more command received by the communication port for executing the stored command; and executes the stored command after a previous command that changes a setting of the management port, when the previous command that changes the setting of the management port is executed, in which the management apparatus includes: a generation unit that generates one or more command, including a first command that changes a setting of the management port in the communication processing apparatus and a second command that is executed after the first command, when the first command that changes a setting of the management port in the communication processing apparatus is executed; and a transmit unit that transmits the one or more command generated by the generation unit to the communication processing apparatus and directs the communication processing apparatus to execute the one or more command.

According to the present invention, the generation unit generates the one or more command including a communication mode set command that sets a communication mode of the communication processing apparatus, a management set command that sets the management port of the communication processing apparatus to the communication port, and a start execution command that instructs to start sequential execution of the one or more command.

In an aspect of the present invention, a computer-readable medium storing a program for a management apparatus that transmits one or more SNMP-based command to a communication processing apparatus, the communication processing apparatus having a communication port set as a management port which receives the one or more command; stores the one or more command received by the communication port for executing the stored command; and executes the stored command after a previous command that changes a setting of the management port, when the previous command that changes the setting of the management port is executed, the computer-readable medium storing a program includes: a generation module that directs the management apparatus to generate one or more command including a first command that changes a setting of the management port in the communication processing apparatus; and a transmit module that directs the management apparatus to transmit the one or more command generated by the management apparatus.

According to the present invention, a computer-readable medium storing a program, in which the generation module directs the management apparatus to generate the one or more command including a communication mode set command that sets a communication mode of the communication processing apparatus, a management set command that sets the management port of the communication processing apparatus to the communication port, and a start execution command that instructs to start sequential execution of the one or more command.

In an aspect of the present invention, a communication system having a communication processing apparatus that receives an SNMP-based command to execute the received command and a management apparatus transmitting the command to the communication processing apparatus, the communication processing apparatus includes: a first communication port, which is set as a management port, which receives one or more command transmitted from the management apparatus to the communication processing apparatus, the one or more command including a first command that is executable to change a setting of the management port and a second command; a storage unit that stores the one or more command received by the first communication port; an execution unit that obtains the one or more command from the storage unit to execute the obtained command; and a re-execution instruction unit that makes the execution unit execute the second command after the first command that changes a setting of the management port, when the execution unit executes the first command that changes the setting of the management port, and the management apparatus includes: a generation unit that generates the one or more command including the first command that changes the setting of the management port in the communication processing apparatus and the second command; and a transmit unit that transmits the one or more command generated by the generation unit to the communication processing apparatus and directs the communication processing apparatus to execute the one or more command.

In another aspect of the present invention, a communication system, in which the communication processing apparatus further includes a second communication port connected to an external communication apparatus; a communication mode selecting unit that selects one communication mode of a plurality of communication modes to specify each of a plurality of communication operations in the communication processing apparatus; and a management port selecting unit that selects the management port from one of the first communication port and the second communication port, in the management apparatus, the generation unit generates the one or more command including a communication mode set command that sets a communication mode of the communication processing apparatus, a management set command that sets the management port of the communication processing apparatus to the first communication port, and a start execution command that instructs to start sequential execution of the one or more command stored in the storage unit, and in the communication processing apparatus, the execution unit sequentially obtains the one or more command stored in the storage unit to execute the obtained command, the communication mode selecting unit selects the communication mode specified by the communication mode set command, when the communication mode set command is executed, the management port selecting unit selects a default management port, corresponding to the communication mode selected by the communication mode selecting unit, from the first communication port and the second communication port, the re-execution instruction unit instructs the execution unit to execute the management port set command after execution of the communication mode set command, and the management port selecting unit selects the first communication port as the management port, when the management port set command is executed.

This summary of the present invention does not necessarily describe all necessary features so that the invention may also be a sub-combination of these described features.

### BRIEF DESCRIPTION OF DRAWINGS

FIG. 1 shows one example of a communication system 100 of an embodiment in the present invention.

FIG. 2 shows components in an interconnecting device 110 of a preferred embodiment in the present invention.

FIG. 3 shows components in a management apparatus 120 of a preferred embodiment in the present invention.

FIG. 4 shows hardware components in the management apparatus 120 of a preferred embodiment in the present invention.

FIG. 5 shows one example of an operation in a communication mode “0” of the communication system 100 of a preferred embodiment in the present invention.

FIG. 6 shows one example of an operation in a communication mode “1” in the communication system 100 of a preferred embodiment in the present invention.

FIG. 7 is a flowchart of processing a command in an interconnecting device 110 according to a preferred embodiment in the present invention.

FIG. 8 is a time chart of processing a command in the communication system 100 according to a preferred embodiment in the present invention.

### DETAILED DESCRIPTION

The invention will now be described based on preferred embodiments, which do not intend to limit the scope of the present invention, but rather to exemplify the invention. All of the features and the combinations thereof described in the embodiments are not necessarily essential to the invention.

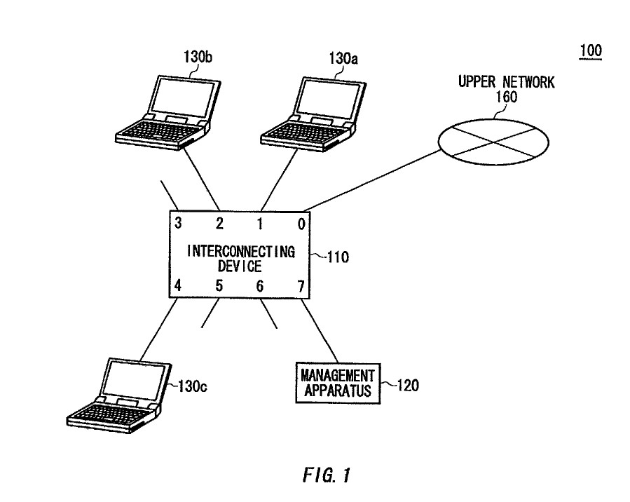

FIG. 1 shows one example of a communication system 100 of an embodiment in the present invention. Communication system 100 of the preferred embodiment includes interconnecting device 110, management apparatus 120, terminals 130a to 130c and upper network 160. Interconnecting device 110 is an example of a communication processing apparatus of the present invention. Terminals 130a to 130c and equipment connected to the interconnecting device 110 from the upper network 160 are examples of communication apparatuses.

Interconnecting device 110 is an interconnecting device for interconnecting communication among communication ports 0 to 7. Interconnecting device 110 may be, for example, a hub, a bridge, a router, a gateway, or the like. Management apparatus 120 is a management apparatus for managing interconnecting device 110 using an SNMP command. A command of the present embodiment can be realized by writing a command type and a command parameter using a SET REQUEST message of SNMP into a command receiving register provided as an MIB (management information base) in interconnecting device 110. Management apparatus 120 is directly connected to communication port 7 in interconnecting device 110. Management apparatus 120 may be connected to interconnecting device 110 via another interconnecting device (not shown). Terminals 130a to 130c are terminals having a communication function such as a PC, a work station, or an X terminal. Upper network 160 is a network of an upper layer of a LAN constituted by interconnecting device 110, management apparatus 120 and terminals 130a to 130c.

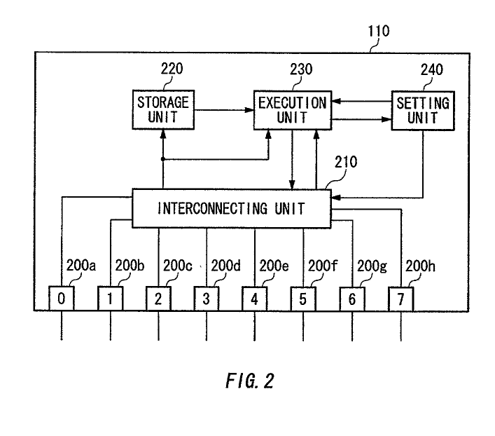

FIG. 2 shows components in interconnecting device 110 of the embodiment in the present invention. Interconnecting device 110 includes communication ports 200a to 200h, interconnecting unit 210, storage unit 220, execution unit 230 and setting unit 240. In a preferred embodiment, setting unit 240, for example, includes a re-execution instruction unit, a communication mode selecting unit, a management port selecting unit and a VLAN setting unit according to the present invention.

Communication ports 220a to 200h are communication ports respectively connected to each of a plurality of external communication apparatuses (not shown). In the present embodiment, one of the communication ports 200a to 200h is set to a management port and receives one or more command from the management apparatus 120. Communication ports 200a to 200h respectively corresponds to communication ports 0 to 7.

Interconnecting unit 210 interconnects communication between communication ports 200a to 200h. Storage unit 220 stores one or more command, received by the communication port set as a management port of communication ports 200a to 200h. Execution unit 230 obtains a command stored by storage unit 220 and sequentially executes the command.

When the execution unit 230 executes a set command that sets each setting of each unit component in interconnecting device 110, the setting unit 240 changes the setting of each unit in the interconnecting device 110 based on the set command. After the setting unit 240 finishes the setting of each unit in interconnecting device 110, the setting unit 240 instructs execution unit 230 to execute another command that follows the executed set command.

In the present embodiment, execution unit 230 and setting unit 240 support three types of set commands, “communication mode set command”, “management port set command”, and “VLAN set command”, as set commands that change a setting of the management port.

When setting unit 240 sets the setting requested by the “communication mode set command”, setting unit 240 selects one of a plurality of communication modes to specify each of a plurality of communication operations in interconnecting device 110 to set the selected communication mode. Setting unit 240 selects a management port of default, corresponding to the set communication mode, from communication ports 200a to 200h to set the selected port as a management port. Setting unit 240 sets a VLAN (virtual LAN) of default corresponding to the set communication mode for interconnecting unit 210. Interconnecting device 110 in the present embodiment, for example, has two communication modes of communication, i.e., modes “0” and “1”.

When setting unit 240 sets the setting requested by the “management port set command”, setting unit 240 sets the management port to the communication port specified by the “management port set command” for interconnecting unit 210.

When setting unit 240 sets the setting requested by the “VLAN set command”, setting unit 240 sets a combination of communication ports 200a to 200h capable of interconnecting communication for interconnecting unit 210, i.e., setting unit 240 sets interconnecting unit 210 to control communication between communication ports 200a to 200h corresponding to the selected communication mode.

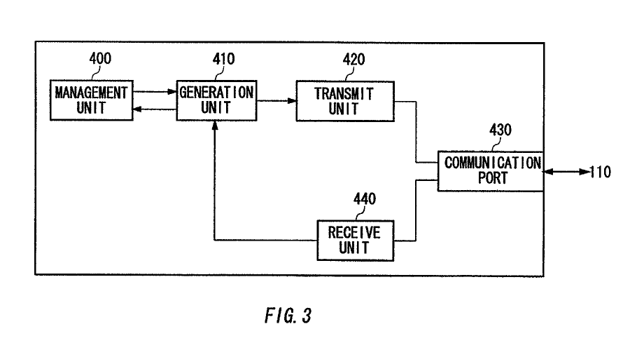

FIG. 3 shows components in management apparatus 120 of the embodiment in the present invention. Management apparatus 120 includes management unit 400, generation unit 410, transmit unit 420, communication port 430, and receive unit 440. Transmit unit 420 and communication port 430 is one example of a transmit unit in the present invention.

When an administrator of communication system 100 or a management function of interconnecting device 110 in management unit 400 makes a request, management unit 400 instructs generation unit 410 so that management unit 400 makes interconnecting device 110 process one or more command. Generation unit 410 is instructed by management unit 400 and generates one or more command. Transmit unit 420 transmits the one or more command in generation unit 410 to the communication port in interconnecting device 110, via communication port 430, and the one or more transmitted command is executed. A command in generation unit 410 may include a command to change a setting of the management port in interconnecting device 110.

Interconnecting device 110 executes each command transmitted from the management apparatus 120 and transmits an execution result of the executed one or more command to management apparatus 120. For example, when each command is a “SET REQUEST” message of SNMP, the execution result may be transmitted as a “GET RESPONSE” massage, which is a response to each “SET REQUEST” message.

Receive unit 440 receives the execution result of the executed one or more command, via communication port 430, and informs generation unit 410 of the result. Generation unit 410 receives the execution result of the executed one or more command and deletes the corresponding generated one or more command to inform management unit 400 of the execution result of the generated one or more command.

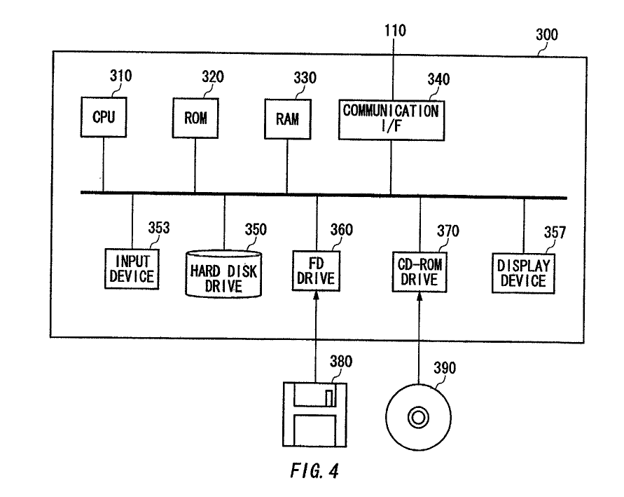

FIG. 4 shows hardware components in management apparatus 120 of the embodiment in the present invention. A function of management apparatus 120 according to the present embodiment is realized by association of a computer 300 with a program executed in computer 300. Computer 300 includes CPU 310, ROM 320, RAM 330, communication interface 340, hard disk drive 350, input device 353, and display device 357. Computer 300 may further include a floppy disk drive 360 and/or CD-ROM drive 370.

The associated program makes computer 300 operate as management unit 400, generation unit 410, transmit unit 420, communication port 430, and receive unit 440. To realize it, the program has a management module, a generation module, a transmit module, and a receive module. These modules make computer 300 operate as the management unit 400; generation unit 410; transmit unit 420 and communication port 430; and receive unit 440 and communication port 430, respectively.

The aforementioned program may be stored in an external computer-readable medium. As the computer-readable medium, an optical recording medium such as a DVD, a magnetic recording medium such as a MD, an optical magnetic recording medium such as a PD, a tape medium, and a semiconductor memory such as an IC card can be used other than a floppy disk 380 and CD-ROM 390. A storage device such as a hard disk or the RAM in a server system connected to a dedicated communication network or an Internet is used as a recording medium and the program may be provided in management apparatus 120 via a communication net.

Such a recording medium is used only to realize management apparatus 120 and it is obvious that manufacturing and selling etc. as a business the recording medium infringes the patent right based on the present application.

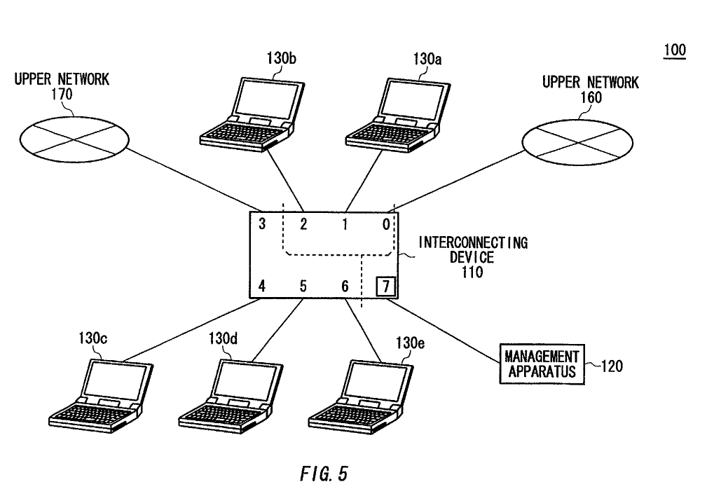

FIG. 5 shows one example of an operation in a communication mode “0” of communication system 100 of the embodiment in the present invention. When a mode is set to the communication mode “0”, interconnecting device 110 provides a plurality of VLANs connected to different upper networks. Interconnecting device 110 in FIG. 5 provides communication ports 0 to 2 as a VLAN having upper network 160 and terminals 130a to 130b, provides communication ports 3 to 6 as a VLAN having upper network 170 and terminals 130c to 130e, and provides communication port 7 as a VLAN for management having management apparatus 120.

Setting unit 240 in interconnecting device 110 (note FIG. 2) sets interconnecting unit 210 so that communication can be interconnected among communication ports 0 to 2 and among communication ports 3 to 6 in the communication mode “0”. Thereby, interconnecting unit 210 prohibits communication among the VLAN by communication ports 0 to 2, the VLAN by communication ports 3 to 6, and the VLAN by communication port 7, thus, independence of the VLANs is kept.

Communication port 7 is operated as a management port of default corresponding to the communication mode “0” by setting unit 240 of the present embodiment. In FIG. 5, communication port 7 is surrounded by a box and illustrated as the management port of default.

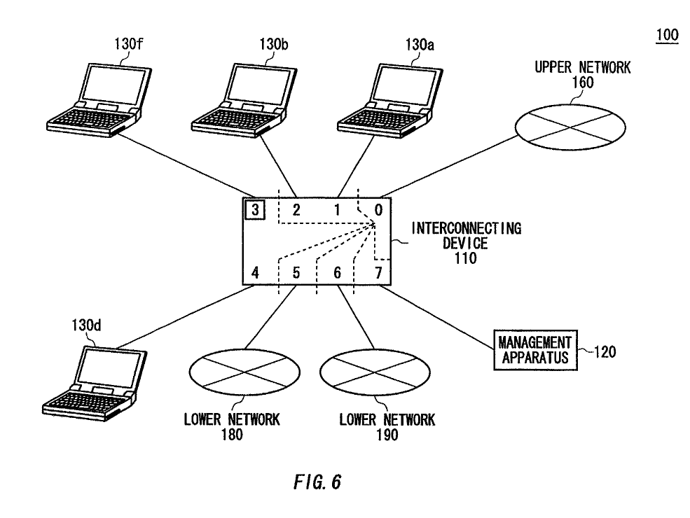

FIG. 6 shows one example of an operation in a communication mode “1” in communication system 100 of the embodiment in the present invention. When the mode is set to the communication mode “1”, interconnecting device 110 provides a plurality of VLANs connected to the same upper network 160 by using communication port 0. Interconnecting device 110 in FIG. 6 provides communication ports 0 to 2 as the VLAN having upper network 160 and terminals 130a to 130b; provides communication ports 0, 3, and 4 as the VLAN having upper network 160, terminal 130f, and terminal 130d; provides communication ports 0 and 5 as the VLAN having upper network 160 and lower network 180; provides communication ports 0 and 6 as the VLAN having upper network 160 and lower network 190; and provides communication port 7 as the VLAN having management apparatus 120. In the communication mode “1”, communication port 0 is operated as a virtual plurality of communication ports connecting each of the VLANs provided by interconnecting device 110 to upper network 160.

Interconnecting unit 210 in interconnecting device 110 (note FIG. 2) is set so that communication can be interconnected among communication ports 0 to 2; among communication ports 0, 3, and 4; between communication ports 0 and 5; or between communication ports 0 and 6 in FIG. 6. Thereby, interconnecting unit 210 prohibits communication among the VLAN of communication ports 0 to 2; the VLAN of communication ports 0, 3, and 4; the VLAN of communication ports 0 and 5; and the VLAN of communication ports 0 and 6, thus, independence of the VLANs is kept.

Communication port 3 is operated as the management port of default corresponding to the communication mode “1” by setting unit 240 of the present embodiment. In FIG. 6, communication port 3 is surrounded by a box and illustrated as the management port of default.

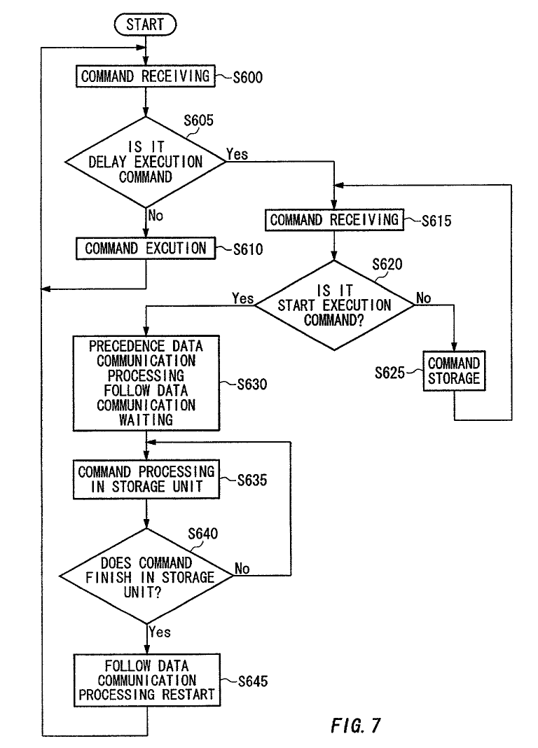

FIG. 7 is a flowchart of processing a command in interconnecting device 110 according to the present embodiment in the present invention.

Generation unit 410 in management apparatus 120 (note FIG. 3) generates one or more command for interconnecting device 110. Transmit unit 420 and communication port 430 in management apparatus 120 sequentially transmit each generated command to interconnecting device 110.

A management port, which is any of the communication ports 200a to 200h in interconnecting device 110 (note FIG. 2), receives a command transmitted by management apparatus 120. Storage unit 220 in interconnecting device 110 obtains the command transmitted by management apparatus 120, via interconnecting unit 210, and stores the command (S600).

When the received command is not “delay execution command” (S605), which is a command to start storing a series of subsequent commands in storage unit 220, execution unit 230 executes the command (S610) and a routine proceeds to S600. At that time, storage unit 220 deletes the command corresponding to the command executed by execution unit 230 from storage unit 220 in an FIFO order (first-in first-out order). When the received command is the “delay execution command” (S605), the routine proceeds to S615.

Storage unit 220 receives a command transmitted by management apparatus 120, via the management port and interconnecting unit 210, to store the command (S615).

When the received command is not “start execution command” (S620), which instructs the execution of the series of commands stored in storage unit 220, the routine proceeds to S615. At that time, storage unit 220 stores the received command (S625). When the received command is the “start execution command” (S620), the routine proceeds to S630.

By processing from S600 to S625, storage unit 220 stores all the commands received between the “delay execution command” and the “start execution command” in FIFO order, until a time when execution unit 230 proceeds the routine to S630.

Execution unit 230 instructs interconnecting unit 210 to complete interconnect of communication that was received by interconnecting unit 210 before the “start execution command” is received. Interconnecting unit 210 completes the interconnect of communication, which is judged by interconnecting unit 210 to have been received before the “start execution command”, and informs execution unit 230 of the completion of communication interconnect. Execution unit 230 instructs interconnecting unit 210 to delay the interconnect of communication which is judged by interconnecting unit 210 to have been received after the “start execution command” was received. Judgment of the relationship “before/after receipt of the start execution command” can be carried out in various methods (S630). The various methods are, for example, a method so that a receiving time is recorded as a time stamp when communication ports 200a to 200h receive a packet, etc. and interconnecting unit 210 judges the relationship “before/after receipt of the start execution command” based on the time stamp; and a method so that all or one part of the received packet, etc. is recorded in one FIFO queue, and judgment is carried out based on the relationship “before/after receipt of the start execution command” in the FIFO queue.

Execution unit 230 sequentially executes commands from the “delay execution command” stored in storage unit 220 to the “start execution command” (S635). When execution unit 230 finishes execution of the commands before the “start execution command” in storage unit 220, execution unit 230 makes interconnecting unit 210 restart interconnect of communication that is judged by interconnecting unit 210 as received after the “start execution command” (S645). Execution unit 230 proceeds the routine to S600.

Interconnecting device 110 according to the present embodiment receives an SNMP-based command from management apparatus 120 and can execute the command. When interconnecting device 110 receives a “delay execution command”, interconnecting device 110 stores all commands that are received thereafter until a “start execution command” is received after the “delay execution command” in storage unit 220; and can carry out batch execution of the commands stored in storage unit 220 when the “start execution command” is received.

When the “start execution command” is received, and after completion of the interconnect of communication that is judged to have been already received by the communication ports 200a to 200h when the “start execution command” is received, interconnecting device 110 can execute commands stored in storage unit 220.

Interconnecting device 110 can delay the interconnect of communication until execution of commands stored in storage unit 220 is completed when the “start execution command” is received before receiving the delayed communication.

Judgment is performed after the “start execution command” is received.

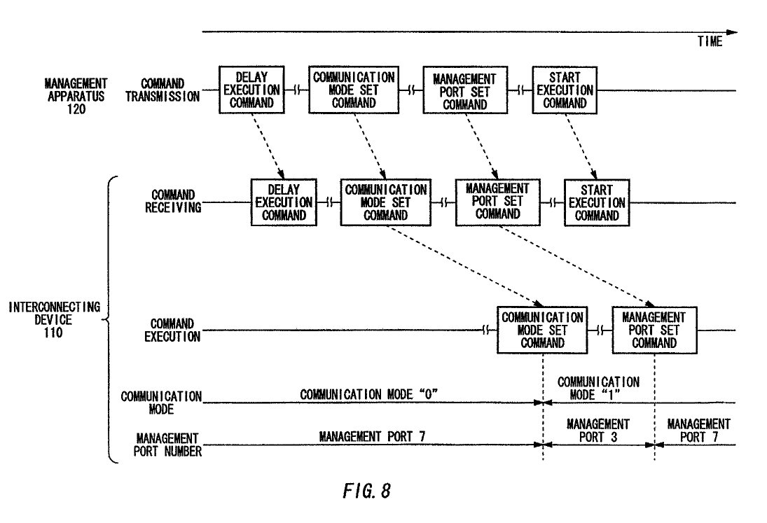

FIG. 8 is a time chart of processing a command in communication system 100 according to the present embodiment in the present invention. The time chart shows an operation in which a command is transmitted from management apparatus 120 to interconnecting device 110, which is set for a network as depicted in FIG. 5, and interconnecting device 110 is set so as to switch to a network as depicted in FIG. 6. A horizontal axis shows passage of time and a vertical axis in FIG. 8 shows command transmission in management apparatus 120, command receiving and command execution in interconnecting device 110, and the communication mode and a management port number in interconnecting device 110.

Before management apparatus 120 transmits a command to interconnecting device 110, the communication mode in interconnecting device 110 is set to 0 and the management port is set to communication port 7.

Management apparatus 120 generates one or more command including “delay execution command”, “communication mode set command”, “management port set command”, and “start execution command”, and sequentially transmits each command to interconnecting device 110. Communication port 7, specified as the management port of interconnecting device 110, receives the commands transmitted by management apparatus 120. Storage unit 220 in interconnecting device 110 stores the commands. Since the commands in FIG. 8 begin with the “delay execution command”, interconnecting device 110 does not execute the stored commands until the “start execution command” is received.

When the “start execution command” is received, execution unit 230 starts to execute the commands from the “delay execution command” to the “start execution command” stored in storage unit 220. Execution unit 230 makes setting unit 240 select the communication mode “1” and makes setting unit 240 change the communication mode from “0” to “1” when the “communication mode set command” is executed. Therefore, setting unit 240 selects communication port 3, which is another communication port from communication port 7 and which is a management port of default in the communication mode “1”, and sets communication port 3 to the management port. Setting unit 240 sets a combination of communication ports capable of interconnecting communication for interconnecting unit 210 corresponding to the communication mode “1”.

Execution unit 230 in interconnecting device 10 sets a communication port specified as a parameter to the management port when “management port set command” is executed. In FIG. 8, execution unit 230 sets the management port to communication port 7.

Management apparatus 120 may insert any suitable or desired command between “delay execution command” and “communication mode set command” or between “communication mode set command” and “management port set command” or between “management port set command” and “start execution command”. For example, when the default VLAN setting in the communication mode “1” in interconnecting device 110 is different from the VLAN setting shown in FIG. 6, a “VLAN set command” is inserted and setting of the VLAN may be performed.

Interconnecting device 110 sequentially receives one or more command, including “communication mode set command”, “management port set command”, and “start execution command”, to store the received commands. Interconnecting device 110 can sequentially execute the “communication mode set command”, “management port set command”, and “start execution command”. Interconnecting device 110 can continue to execute commands even when the interconnecting device 110 changes the communication mode, as instructed by execution of the “communication mode set command”, and the management port is set to the default management port corresponding to the changed communication mode, i.e., the communication port 3 in the above example. Management apparatus 120 then sets the connected communication port, i.e., the communication port 7 in the above example, to the management port and thereby, management of interconnecting device 110 can be continued without having to change the communication port to which the management apparatus 120 is connected.

Management apparatus 120 generates a “delay execution command” before a command for changing a setting of the management port, such as a “communication mode set command”, and generates a “management port set command” and “start execution command” after the “communication mode set command.” Thereby, management apparatus 120 can return the management port to the communication port to which management apparatus 120 is connected, i.e., the communication port 7 in the above example, when execution of the one or more command is completed. Management of interconnecting device 110 can be continued without having to change the communication port to which the management apparatus 120 is connected.

As discussed above, execution unit 230 can use a “delay execution command” and “start execution command” according to the present embodiment when a series of commands to change a protocol of the management port, such as a communication speed or a data format of the management port, is executed. Thereby, it is possible to prevent disruption or blocking of communication between management apparatus 120 and interconnecting device 110 in a state where only one part of the protocol of the management port is changed.

With respect to a protocol based on SNMP as defined in the future, such a protocol can be applied to the present invention if the protocol is based on a basic SNMP protocol.

According to the present invention, it is possible to avoid a status or condition in which a command from a management apparatus is not accepted by a communication apparatus because communication between the apparatuses is disrupted by change in a management port setting.

Although the present invention has been described by way of exemplary embodiments, it should be understood that many changes and substitutions may be made by those skilled in the art without departing from the spirit and the scope of the present invention which is defined only by the appended claims.

1. A communication processing apparatus that receives an SNMP-based command to execute said received command, comprising:
a first communication port, which is set as a management port, that receives one or more command transmitted from a management apparatus of said communication processing apparatus to said communication processing apparatus, said one or more command including a first command that is executable to change a setting of said management port and a second command;
a storage unit that stores said one or more command received by said first communication port;
an execution unit that obtains said one or more command from said storage unit to execute said obtained command; and
a re-execution instruction unit that directs said execution unit to execute said second command after said first command that changes said setting of said management port, when said execution unit has executed said first command that changes said setting of said management port.

2. A communication processing apparatus as claimed in claim 1, wherein:
said second command is received by said first communication port after said first command and is executable to set said management port of said communication processing apparatus to said first communication port.

3. A communication processing apparatus as claimed in claim 1, further comprising:
a second communication port connected to an external communication apparatus;
a communication mode selecting unit that selects one communication mode of a plurality of communication modes to specify each of a plurality of communication operations of said communication processing apparatus; and
a management port selecting unit that selects said management port from one of said first communication port and said second communication port, wherein said management port selecting unit selects said first communication port as said management port;
said execution unit obtains said one or more command stored in said storage unit to execute said obtained command when said first communication port receives said one or more command including
a communication mode set command that specifies a communication mode of said communication processing apparatus, a management port set command that sets said management port of said communication processing apparatus to said first communication port, and a start execution command that instructs to start sequential execution of said one or more command stored in said storage unit;
said communication mode selecting unit selects said communication mode specified by said communication mode set command, when said communication mode set command is executed;
said management port selecting unit selects a default management port, corresponding to said communication mode selected by said communication mode selecting unit, from said first communication port and said second communication port;
said re-execution instruction unit instructs said execution unit to execute said second command after execution of said communication mode set command; and
said management port selecting unit selects said first communication port as said management port, when said management port set command is executed.

4. A communication processing apparatus as claimed in claim 3, further comprising:
an interconnecting unit that interconnects communication between said first communication port and said second communication port; and
a VLAN setting unit that sets said interconnecting unit to control communication between said first communication port and said second communication port corresponding to said communication mode selected by said communication mode selecting unit.

5. A communication processing apparatus as claimed in claim 1, further comprising:
a second communication port connected to an external communication apparatus;
an interconnecting unit that interconnects communication between said first communication port and said second communication port, wherein
said execution unit obtains said one or more command stored in said storage unit to execute said obtained command when said first communication port set as said management port receives a start execution command that instructs to start sequential execution of said one or more command stored in said storage unit, and
it is determined that said interconnect of said communication between said first communication port and said second communication port, received before said first communication port receives said start execution command, is completed.

6. A communication processing apparatus as claimed in claim 1, further comprising:
a second communication port connected to an external communication apparatus;
an interconnecting unit that interconnects communication between said first communication port and said second communication port, wherein
said execution unit delays said interconnect of said communication between said first communication port and said second communication port until execution of said one or more command stored in said storage unit is completed, when said communication between said first communication port and said second communication port is received after said first communication port set as said management port receives a start execution command that instructs to start sequential execution of said one or more command stored in said storage unit.

7. A management apparatus that transmits one or more SNMP-based command to a communication processing apparatus, said communication processing apparatus having a communication port set as a management port which receives said one or more command; stores said one or more command received by said communication port for executing said stored command; and executes said stored command after a previous command that changes a setting of said management port, when said previous command that changes said setting of said management port is executed, said management apparatus comprising:
a generation unit that generates one or more command, including a first command that changes a setting of the management port in the communication processing apparatus and a second command that is executed after said first command, when said first command that changes a setting of the management port in the communication processing apparatus is executed; and
a transmit unit that transmits said one or more command generated by said generation unit to the communication processing apparatus and directs the communication processing apparatus to execute said one or more command.

8. A management apparatus as claimed in claim 7, wherein said generation unit generates said one or more command including
a communication mode set command that sets a communication mode of said communication processing apparatus, a management set command that sets said management port of said communication processing apparatus to said communication port, and a start execution command that instructs to start sequential execution of said one or more command.

9. A computer-readable medium storing a program for a management apparatus that transmits one or more SNMP-based command to a communication processing apparatus, said communication processing apparatus having a communication port set as a management port which receives said one or more command; stores said one or more command received by said communication port for executing said stored command; and executes said stored command after a previous command that changes a setting of said management port, when said previous command that changes said setting of said management port is executed, said computer-readable medium storing a program comprising:
a generation module that directs the management apparatus to generate one or more command including a first command that changes a setting of the management port in the communication processing apparatus; and
a transmit module that directs the management apparatus to transmit said one or more command generated by the management.

10. A computer-readable medium storing a program as claimed in claim 9, wherein said generation module directs the management apparatus to generate said one or more command including
a communication mode set command that sets a communication mode of said communication processing apparatus, a management set command that sets said management port of said communication processing apparatus to said communication port, and a start execution command that instructs to start sequential execution of said one or more command.

11. A communication system comprising a communication processing apparatus that receives an SNMP-based command to execute said received command and a management apparatus transmitting said command to said communication processing apparatus, said communication processing apparatus comprising:
a first communication port, which is set as a management port, which receives one or more command transmitted from said management apparatus to said communication processing
apparatus, said one or more command including a first command that is executable to change a setting of said management port and a second command;
a storage unit that stores said one or more command received by said first communication port;
an execution unit that obtains said one or more command from said storage unit to execute said obtained command; and
a re-execution instruction unit that makes said execution unit execute said second command after said first command that changes a setting of said management port, when said execution unit executes said first command that changes said setting of said management port,
said management apparatus comprising:
a generation unit that generates said one or more command including said first command that changes said setting of said management port in said communication processing apparatus and said second command; and
a transmit unit that transmits said one or more command generated by said generation unit to said communication processing apparatus and directs said communication processing apparatus to execute said one or more command.

12. A communication system as claimed in claim 11, wherein said communication processing apparatus further comprises
a second communication port connected to an external communication apparatus;
a communication mode selecting unit that selects one communication mode of a plurality of communication modes to specify each of a plurality of communication operations in said communication processing apparatus; and
a management port selecting unit that selects said management port from one of said first communication port and said second communication port, wherein in said management apparatus, said generation unit generates said one or more command including
a communication mode set command that sets a communication mode of said communication processing apparatus, a management set command that sets said management port of said communication processing apparatus to said first communication port, and a start execution command that instructs to start sequential execution of said one or more command stored in said storage unit, and
in said communication processing apparatus, said execution unit sequentially obtains said one or more command stored in said storage unit to execute said obtained command,
said communication mode selecting unit selects said communication mode specified by said communication mode set command, when said communication mode set command is executed,
said management port selecting unit selects a default management port, corresponding to said communication mode selected by said communication mode selecting unit, from said first communication port and said second communication port,
said re-execution instruction unit instructs said execution unit to execute said management port set command after execution of said communication mode set command, and
said management port selecting unit selects said first communication port as said management port, when said management port set command is executed.
